(19) United States
(12) Patent Application Publication
(10) Pub. No.: US 2002/0123907 A1
(43) Pub. Date: Sep. 5, 2002

(54) System and software for capturing and encoding healthcare servives and processing healthcare claims

(76) Inventor: Scott M. Strayer, Charlottesville, VA (US)

Correspondence Address: Anthony R. Johnson, Suite 3, Eagle Center One, O'Fallon, IL, 62269, US

(21) Appl. No.: 10/011,596

(22) Filed: Feb. 13, 2002

Related U.S. Application Data
(60) Provisional application No. 60/250,752, filed on Dec. 2, 2000.

(51) Int. Cl. G06F 17/60

(52) U.S. Cl. 705/2

(57) ABSTRACT

A method and software system, for capturing and encoding healthcare services and processing healthcare claims, preferably through capturing information at the point of service through a Hand Held Computer 1 relevant to the medical treatment furnished by the healthcare provider, encoding the health care services, and submitting the healthcare claims to a Centralized Coding Facility 4, either directly to the Centralized Coding Facility 4, or from the Hand Held Computer 1 to a Desk Top Computer System 3 and then to the Centralized Coding Facility 4, by means of a hard-wired connection transmission, wireless transmission, or infra-red beam transmission, or combination of those three means, for the purpose of submission of the healthcare claims to the proper insurance company or other paying entity, and for a more expedient, efficient and cost effective payment and reimbursement to the healthcare provider for healthcare services rendered.

### BACKGROUND OF THE INVENTION

1. Field of the Invention

This invention relates generally to the processing of medical claims by healthcare professionals and providers. The invention provides for the capturing and encoding of data relating to a healthcare patient and the healthcare services rendered to that patient. The invention also provides for the submission of claims to the appropriate insurance company or other paying agency, preferably through a Centralized Coding Facility 4, with the objective of receiving payment from the insurance company or other paying agency for the healthcare services rendered, and to do so in an efficient and expedient manner.

Complex software has been available or a good number of years, for use upon the desktop personal computer or larger mainframe computers, for processing medical data and healthcare claims from health care providers, such as hospitals and physicians, to the insurance companies and other paying agencies, such as Medicare and Medicaid. Such existing software and systems have utilized the various generic software packages provided by industry (the Microsoft® Office Package running on the Windows® Operating System, for example), for processing such healthcare claims, mainly through paper forms.

The current invention is distinguishable from the existing software and systems, in at least that the current invention provides for a portable system for accomplishing the tasks discussed herein, including the use of Hand Held Computer is for capturing the relevant healthcare data as discussed herein at the point of service, and that the current invention provides for automatic generation of the charge codes required to be sent to the Central Coding Facility 4, and that the current invention provides for the immediate transmission of healthcare claims information to the Central Coding Facility 4 either directly from the Hand Held Computer 1 or from the Hand Held Computer 1 through a Desk Top Computer System 3.

2. Related Prior Art

The related prior art includes the following patents.

The Rensimer, et al. patent; having U.S. patent Ser. No. 6,154,726; filed Nov. 9, 1998; issued Nov. 28, 2000; and entitled, “System And Method For Recording Patient History Data About On-Going Physical Care Procedures”; discloses an invention which relates to a hand-held physician's computer and database system configured to collect, store, and report historical patient-care information at the site of patient service. The system and method permits a physician, or other care-provider, to record not only patient status information but other patient-treatment information as well. The Rensimer patent teaches that prior patient data systems focused more on data about current patient status than on historical data about the care given to the patient, and that such former data systems conveyed comparatively little or no information about the physician and other medical-staff resources that were previously utilized in caring for the patient. The primary objective of the Rensimer patent was its advantage over the “superbill”. The main inventive features of the Rensimer patent are (1) a novel standard classification system for health care providers; (2) generation of clinical status codes at the point of service; and (3) the entry of other patient-treatment information (such as physician and other medical-staff resources that are utilized in caring for the patient) as well as patient status information.

The Kraftson, et al. patent; having U.S. patent Ser. No. 6,151,581; filed Dec. 16, 1997; issued Nov. 21, 2000; and entitled, “System For And Method Of Collecting And Populating A Database With Physician/Patient Data For Processing To Improve Practice Quality And Health Care Delivery”; discloses a system for acquisition, management and processing of patient clinical information and patient satisfaction information received from a plurality of physician practices to provide practice performance information for a physician practice. The Kraftson patent teaches a patient management and health care management database containing data relevant to the clinical care of patients, to the management of the practices to which the patients belong, and to outcomes of that health care and practice management, and discloses a system which encompasses: (i) designing and administering paper and pen and Hand Held Computer 1 survey instruments; (ii) administering and collecting completed surveys; (iii) building and managing a database of information collected from the surveys; (iv) analyzing data collected from the surveys; (v) and providing clinical practices with summary information. The main inventive features of the Kraftson patent are (1) a health care management database system; and (2) the collection of patient satisfaction information, as well as patient clinical information.

The DiRienzo, et al. patent; having U.S. patent Ser. No. 6,076,066; filed Jan. 19, 1999; issued Jun. 13, 2000; and entitled, “Attachment Integrated Claims System And Operating Method Therefor”; discloses an integrated claims system which permits transmission of a customizable claim form and integrated attachment to an insurance carrier via a non-clearinghouse communications channel. The DiReinzo patent taught a solution to the problem where the hard copy “standard text form” must be accompanied by additional information that does not fit into the standard format.

The Shepard patent; having U.S. patent Ser. No. 6,026,363; filed Jan. 6, 1998; issued Feb. 15, 2000; and entitled, “Medical History Documentation System And Method”; discloses a medical history documentation system and method for recording information relating to at least one of a designated patient's current medical condition, a physical examination, a diagnosis and a treatment plan. The Shepard patent solved the problem of the physician having to dictate a report on each patient encounter. The Shepard patent taught a novel medical history capture system, such that the physician does not need to dictate a report on each patient encounter, but the Shepard patent utilizes a pre-printed form.

The Cave, et al. patent; having U.S. patent Ser. No. 5,970,463; filed May 1, 1996; issued Oct. 19, 1998; and entitled, “Medical Claims Integration And Data Analysis System”; discloses and teaches a novel medical claims analysis system and method which utilizes diagnosis codes and pulls from several databases of diagnostic codes, and which categorizes medical claims into episodes of care having predetermined diagnostic cluster types.

The Hunt, et al. patent; having U.S. patent Ser. No. 5,933,809; filed Feb. 29, 1996; issued Aug. 3, 1999; and entitled, “Computer Software For Processing Medical Billing Record Information”; discloses a system and method utilizing computercoded software instructions capable of being executed by a convention computer microprocessor to perform information processing on pre-existing medical billing record information. The Hunt patent teaches the scanning of pre-existing medical billing record information and solved the then existing problem of the Medicare “72 hour billing rule” violation.

The Moore, et al. patent; having U.S. patent Ser. No. 5,930,759; filed Apr. 30, 1996; issued Jul. 27, 1999; and entitled, “Method And System For Processing Health Care Electronic Data Transactions”; disclosed a then improved system for preparing and processing health care data transactions and insurance claims. More specifically, the Moore patent teaches a network for assembling, filing and processing health care data transactions and insurance claims made by patients pursuant to health care policies issued to the patients by insurance companies or other carriers for service provided to the patients at health care facilities, wherein the network comprises a multitude of participating patients, a multitude of health care facilities, and a plurality of insurance companies or other carriers.

The Peterson, et al. patent; having U.S. patent Ser. No. 5,903,873; filed May 31, 1996; issued May 11, 1999; and entitled, “System For Registering Insurance Transactions And Communicating With A Home Office”; teaches the night registration of insurance transactions to a home office computer.

The Burks, et al. patent; having U.S. patent Ser. No. 5,644,778; filed Nov. 2, 1993; issued Jul. 1, 1997; and entitled, “Medical Transaction System”; discloses a medical transaction system permitting a plurality of healthcare providers to communicate with a plurality of payors and financial institutions; and the processing of medical claims without requiring a centralized database or imposing a uniform claim format on the healthcare providers and payors.

The Dorne patent; having U.S. patent Ser. No. 5,325,293; filed Feb. 18, 1992; issued Jun. 28, 1994; and entitled, “System And Method For Correlating Medical Procedures And Medical Billing Codes”; discloses a method of generating official billing codes in response to selected medical procedures.

The Miller patent; having U.S. patent Ser. No. 5,235,702; filed Apr. 11, 1990; issued Aug. 10, 1993; and entitled, “Automated Posting Of Medical Insurance Claims”; discloses a system for the automated posting of medical insurance claims that is based on the use of scanner and optical character recognition technology to scan paper forms, and is combined with software.

The Sackler, et al. patent; having U.S. patent Ser. No. 5,235,507; filed Jan. 16, 1990; issued Aug. 10, 1993; and entitled, “Health Insurance Management System”; discloses an automatic health insurance management system which verifies the insurance status of the claimant, identifies the appropriate insurance policy, calculates the amount to be paid to the health care provider, pays the provider, calculates the payment required by the claimant, if any, and debits the account of the claimant in the amount required.

The Tawil patent; having U.S. patent Ser. No. 5,225,976; filed Mar. 12, 1991; issued Jul. 6, 1993; and entitled, “Automated Health Benefit Processing System”; discloses an automated health benefit processing system specifically having a database and three processors.

The Doyle, Jr., et al. patent; having U.S. patent Ser. No. 5,070,452; filed Oct. 17, 1989; issued Dec. 3, 1991; and entitled, “Computerized Medical Insurance System Including Means To Automatically Update Member Eligibility Files At Pre-Established Intervals”; discloses a computerized insurance claim processing system utilizing a computer link between the physician's office and insurance provider's office by means of a central administration computer.

However, no prior art discloses or teaches the unique features and combination of features of the current invention.

### SUMMARY OF THE INVENTION

The invention discloses and teaches a method and software system, for capturing and encoding healthcare services and processing healthcare claims, preferably through capturing information at the point of service through a Hand Held Computer 1 relevant to the medical treatment furnished by the healthcare provider, encoding the health care services, and submitting the healthcare claims to a Centralized Coding Facility 4, either directly to the Centralized Coding Facility 4, or from the Hand Held Computer 1 to a Desk Top Computer System 3 and then to the Centralized Coding Facility 4, by a hard-wired connection transmission, wireless transmission, or infra-red beam transmission, for submission of the claims to the proper insurance company or other paying agency, and for quicker and even immediate reimbursement to the healthcare provider for healthcare services rendered.

The invention relates generally to the processing of me dical claims by healthcare professionals and providers. The invention provides for the capturing and encoding of data relating to a healthcare patient and the healthcare services rendered to that patient. The invention also provides for the submission of claims to the appropriate insurance company or other paying entity, preferably through a Centralized Coding Facility 4, with the objective of receiving payment from the insurance company or other paying entity for the healthcare services rendered, and to do so in an efficient, cost effective and expedient manner.

This invention is preferably accomplished by utilizing a Hand Held Computer 1, which may capture healthcare patient information and the healthcare services information at the point of service by the healthcare provider, and which may be customized by the healthcare provider for processing said information relating to services rendered to patient. The transmission and submission of healthcare claims to the appropriate insurance company or other paying entity, preferably through a Centralized Coding Facility 4, may be transmitted by means of a hard-wired computer connection, by means of infra-red beaming, or by means of a wireless transmission. The Centralized Coding Facility 4 processes the claims for their submission to the reimbursing agency. Such reimbursing agency may include Medicare, Medicaid, or other insurance company. Thus, the invention primarily relates to the method and process for capturing and encoding pertinent patient data, and linking this data with common procedural codes, for use by the healthcare professional in obtaining quick and cost effective payment for healthcare services from the reimbursing agency.

The current invention includes the development of actual software and graphical user interface, which is installed on a Hand Held Computer 1, such as the Palm® Computer (utilizing the Palm Operating System®, commonly referred to as the “PalmOS®”) and the PocketPC®, and other related Hand Held Computer 1 systems. Such a system enables capturing of patient charges at the “point of service”/“point of care”.

The software of the invention is unique in that it minimizes data entry, in part by relying on the pick-and-tap input means commonly utilized by a Hand Held Computer 1. The software of the invention is customizable to the end user's needs, and has been developed to at least include and interface with software that allows medical information to be converted into Microsoft®, Access®, or Excel® formats for flexible reporting capability. The software was developed using the inventor's proprietary “true practice” development process.

The invention's feature of transmitting the patient and healthcare services information, and Charge Codes to a Centralized Coding Facility 4 is novel, and it follows that the use of hard-wired transmission, wireless transmissions or infra-red beaming transmissions to accomplish the submission to the Centralized Coding Facility 4 is likewise novel. Such submission to a Centralized Coding Facility 4 also represents a method for out-sourcing certain healthcare services coding which is currently done on the premises of the healthcare provider, or by the local biller. The Centralized Coding Facility 4 represents a drastic improvement in efficiency and decreased operating costs for the healthcare provider and enables the healthcare provider to give greater attention to patient care, rather than the administrative procedures involved in billing and receiving reimbursement for healthcare services.

It is, therefore, a primary object of the current invention to provide a system and software, primarily for a Hand Held Computer 1, to handle, primarily on behalf of healthcare providers, the processing of health care patient information, billings and claims, for the efficient and expedient processing of such healthcare billings and claims.

These and other objects may become more apparent to those skilled in the art upon reviewing of this invention, and upon undertaking a study of the description of its preferred embodiment, in view of the drawings.

### BRIEF DESCRIPTION OF THE DRAWINGS

FIG. 1 shows the Pocket Billing Icon 13 viewed on the Applications Menu Screen 12 on a Hand Held Computer 1.

FIG. 2 shows the Main Patient List Screen 14.

FIG. 3 shows the top half of the Patient Information Entry Screen 18.

FIG. 4 shows the bottom half of the Patient Information Entry Screen 27.

FIG. 5 shows the Allergy Selector Screen 28.

FIG. 6 shows the Diagnosis Field Screen 29.

FIG. 7 shows the Family History Screen 30.

FIG. 8 shows the Medication Screen 31.

FIG. 9 shows the Past Surgical History Screen 32.

FIG. 10 shows the Social History Screen 33.

FIG. 11 shows the Notes Screen 34.

FIG. 12 shows the Common Procedural Terminology (CPT ©) Codes Entry Screen 35.

FIG. 13 shows some of the charges available on the Initial Charges Sub-database Screen 41.

FIG. 14 further shows some of the charges available on the Initial Charges Sub-database Screen 42.

FIG. 15 shows some of the charges available on the Subsequent Charges Sub-database Screen 43.

FIG. 16 further shows some of the charges available on the Subsequent Charges Sub-database Screen 44.

FIG. 17 shows some of the charges available on the Procedural Charges Sub-database Screen 45.

FIG. 18 further shows some of the charges available on the Procedural Charges Sub-database Screen 46.

FIG. 19 further still shows some of the charges available on the Procedural Charges Sub-database Screen 47.

FIG. 20 shows some of the charges available on the Emergency Room Charges Sub-database Screen 48.

FIG. 21 shows some of the charges available on the Nursing Home Charges Sub-database Screen 49.

FIG. 22 is a flow chart diagram showing the processing of Patient Data 2 through the system and preferred embodiment software of this invention.

FIG. 23 is a block diagram showing the organization of the system information.

### DESCRIPTION OF THE PREFERRED EMBODIMENT(S)

The present invention is a method or process for capturing and encoding healthcare services and processing healthcare claims. The basic steps of the invention are (a) capturing healthcare services, (b) encoding the healthcare services consists, and (c) processing healthcare claims. In the preferred embodiment of the invention, the step of processing healthcare claims includes submitting the healthcare claims to a Centralized Coding Facility 4. In a further embodiment of the process, the step of Capturing Healthcare Services includes capturing Relevant Information at the point of service utilizing a Hand Held Computer 1. The Relevant Information may include Patient Information, Patient History, Hospital Information, and Specific Instances of Services. The Relevant Information is stored initially in the Hand Held Computer 1 System, and then transferred to the Desk Top Computer System 3. In a further embodiment of the process, the step of Encoding Healthcare Services includes generating one or more of the following Charge Codes: an Initial Charges Code, a Subsequent Charges Code, a Procedures Charges Code, an Emergency Room Services Charges Code, and a Nursing Home Visits Charges Code. The Specific Instances of Services may include Service Location, Patient Allergies, Patient Diagnosis, Patient Medications, Patient Past Surgical History, Patient Past Social History, Patient Family History and Notes. In one embodiment of the process, the Charge Codes are automatically generated by software in the Hand Held Computer 1. In another embodiment of the process, the user of the Hand Held Computer 1 may either accept the automatically generated Charge Codes, or manually select the Charge Codes, or define and select a Customized Charge Code. The submission of Healthcare Claims to a Centralized Coding Facility 4 is accomplished by sending an electronic transmission from the Hand Held Computer 1 to the Centralized Coding Facility 4, where the electronic transmission may be comprised of a transmission by e-mail, over a local area network, over the internet, by means of a modem connection, or by means of another hardwired connection between the Hand Held Computer 1 and the Centralized Coding Facility 4. Alternatively, the submission of Healthcare Claims to a Centralized Coding Facility 4 may be accomplished by sending a wireless transmission from the Hand Held Computer 1 to the Centralized Coding Facility 4. In a further alternative, the submission of Healthcare Claims to the Centralized Coding Facility 4 may be accomplished by sending an infra-red beam from the Hand Held Computer 1 to the Centralized Coding Facility 4. In yet a further alternative, the submission of Healthcare Claims to the Centralized Coding Facility 4 is accomplished by sending a First Transmission 8 from the Hand Held Computer 1 to a Desktop Computer System 3, and then by sending a Second Transmission 9 from the Desktop Computer System 3 to the Centralized Coding Facility 4. The First Transmission 8 may be an electronic transmission by one of the following means: by e-mail, over a local area network, over the internet, by means of a modem connection, or by means of another hardwired connection between the Hand Held Computer 1 and the Desktop Computer System 3; or the First Transmission 8 may be a wireless transmission, preferably a secured wireless transmission; or the First Transmission 8 may be an infra-red beam transmission.

In the preferred embodiment of the process, the user of the Hand Held Computer 1 first goes to the Applications Menu 12 shown in FIG. 1. In the preferred embodiment of the process, the user will tap on the icon 13 corresponding to the process, which is preferably entitled “PocketBilling©”. Moreover, the preferred Pocket Billing Icon 13 is a stethoscope with a dollar sign with the words “Pocket Bill” underneath them.

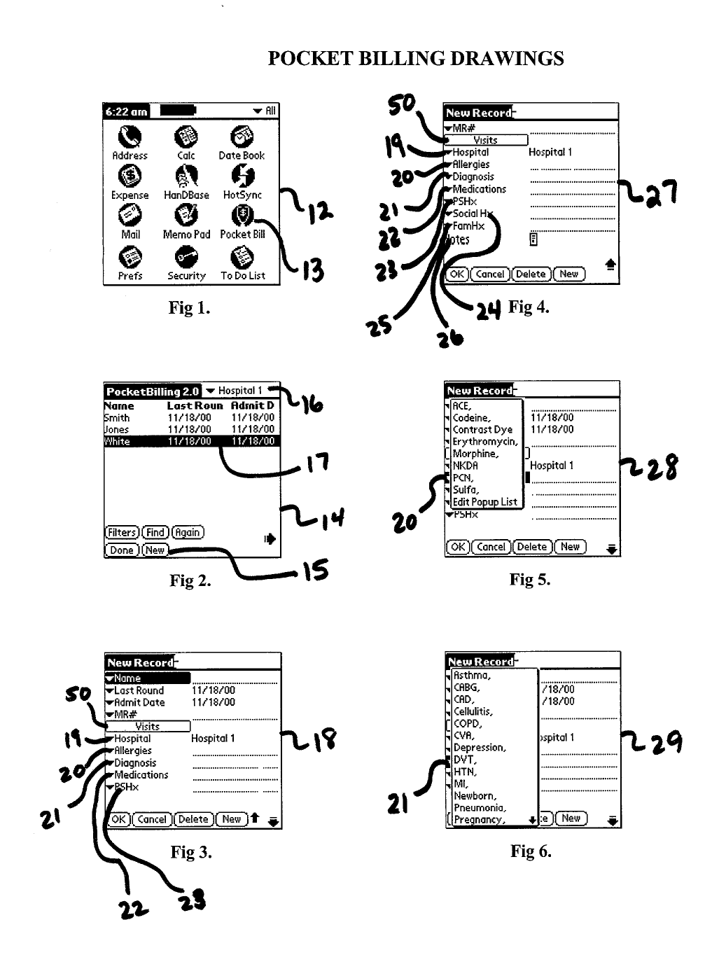

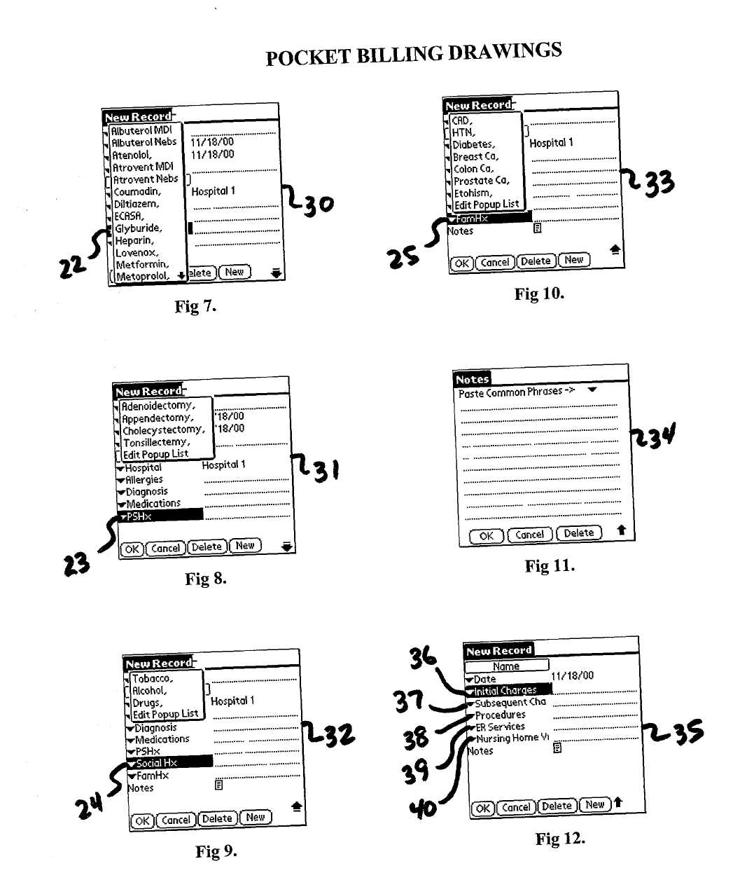

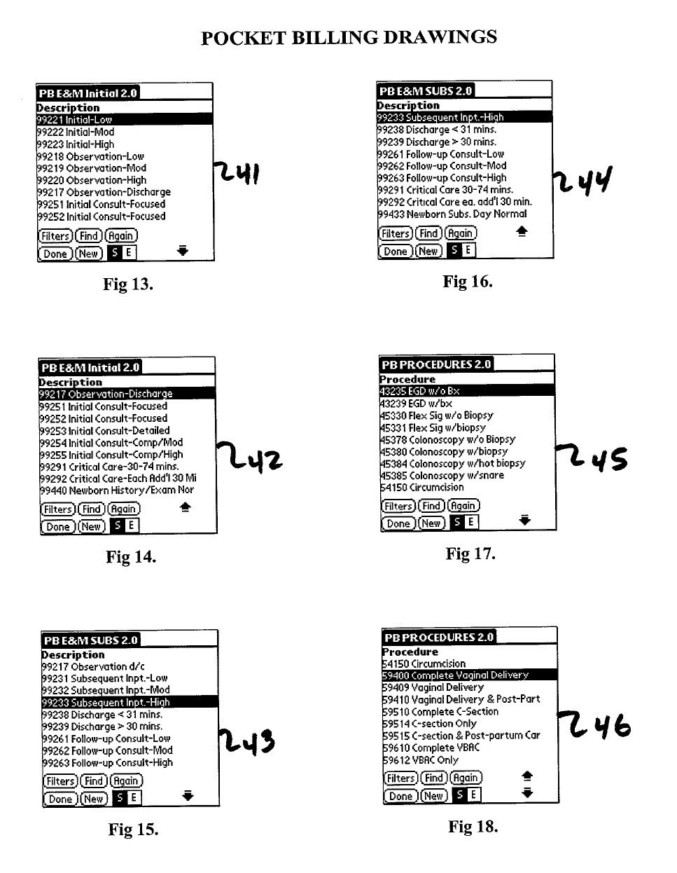

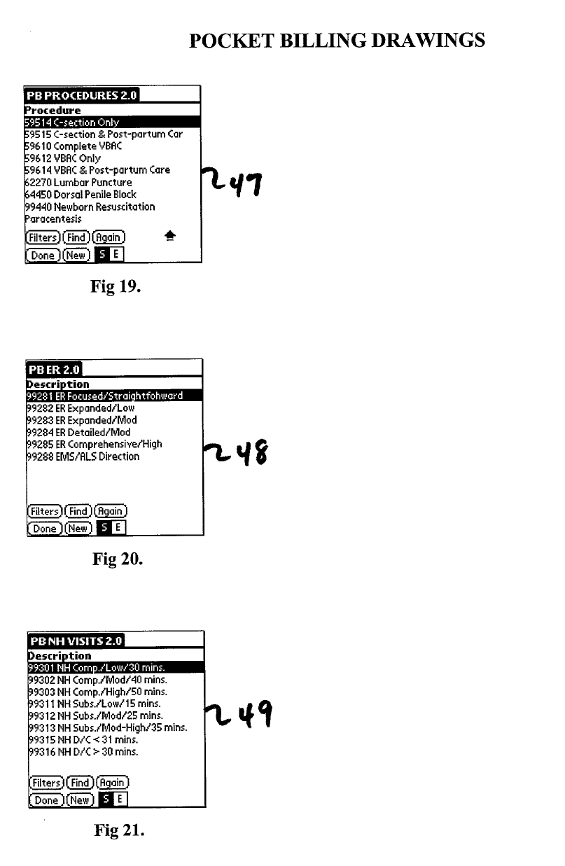

The user will start the PocketBilling process by tapping on the Pocket Billing Icon 13. The Main Patient List Screen 14 shown in FIG. 2 will then appear. On the Main Patient List Screen 14, the user can select from various Hospitals from the “Hospital” Pull Down Menu 16 preferably shown in the upper right hand comer of the Main Patient List Screen 14. Also, the user may select any current patient who may be in the system by tapping the appropriate Patient Line 17. In the preferred embodiment, the user will tap on the “New” Button 15, which will bring the user to the first Patient Information Entry Screen 18 shown in FIG. 3. On the Patient Information Entry Screen 18 & 27, the user may select from several sub-screens, including the Allergy Selector Screen 28 (shown in FIG. 5), the Diagnosis Field Screen 29 (shown in FIG. 6), the Medication Screen 30 (shown in FIG. 7), the Past Surgical History Screen 31 (shown in FIG. 8), the Social History Screen 32 (shown in FIG. 9), the Family History Screen 33 (shown in FIG. 10), and the Notes Screen 34 (shown in FIG. 11). The user moves from the Patient Information Entry Screen 18 & 27 to one of the other screens noted above by tapping on the appropriate sub-screen title/button. To open the Allergy Selector Screen 28 (shown in FIG. 5), the user will tap on the Allergies Button 20 (shown in FIGS. 3, 4 and 5). To open the Diagnosis Field Screen 29 (shown in FIG. 6), the user will tap on the Diagnosis Button 21 (shown in FIGS. 3, 4 and 6). To open the Medications Screen 30 (shown in FIG. 7), the user will tap on the Medications Button 22 (shown in FIGS. 3, 4 and 7). To open the Past Surgical History Screen 31 (shown in FIG. 8), the user will tap on the Past Surgical History Button 23 (shown in FIGS. 3, 4 and 8), which is preferably abbreviated as “PSHx” 23. To open the Social History Screen 32 (shown in FIG. 9), the user will tap on the Social History Button 24 (shown in FIGS. 4 and 9), which is preferably abbreviated as “Social Hx” 24. To open the Family History Screen 33 (shown in FIG. 10), the user will tap on the Family History Button 25 (shown in FIGS. 4 and 10), which is preferably abbreviated as “FamHx” 25. To open the Notes Screen 34 (shown in FIG. 11), the user will tap on the Notes Button 26 (shown in FIG. 4). To select a certain hospital, the user will tap on the Hospital Button 19 (shown in FIGS. 3 and 4).

Upon tapping the Allergies Button 20, the user will see a list of common allergies on the Allergy Selector Screen 28 (shown in part in FIG. 5). The user may either select one or more of the allergies listed or add a customized entry.

Upon tapping the Diagnosis Button 21, the user will see a list of common diagnoses on the Diagnosis Field Screen 29 (shown in part in FIG. 6). The user may either select one or more of the diagnoses listed or add a customized entry.

Upon tapping the Medications Screen 22, the user will see a list of common medications on the Medications Screen 30 (shown in part in FIG. 7). The user may either select one or more of the medications listed or add a customized entry.

Upon tapping the Past Surgical History Button 23, the user will see a list of common surgeries on the Past Surgical History Screen 31(shown in part in FIG. 8). The user may either select one or more of the surgeries listed or add a customized entry.

Upon tapping the Nursing Home Services Button 40, the user will see a list of standard charges with standard charge codes, as shown in part in FIG. 21 49. The user may either select one or more of the charges listed or add a customized entry.

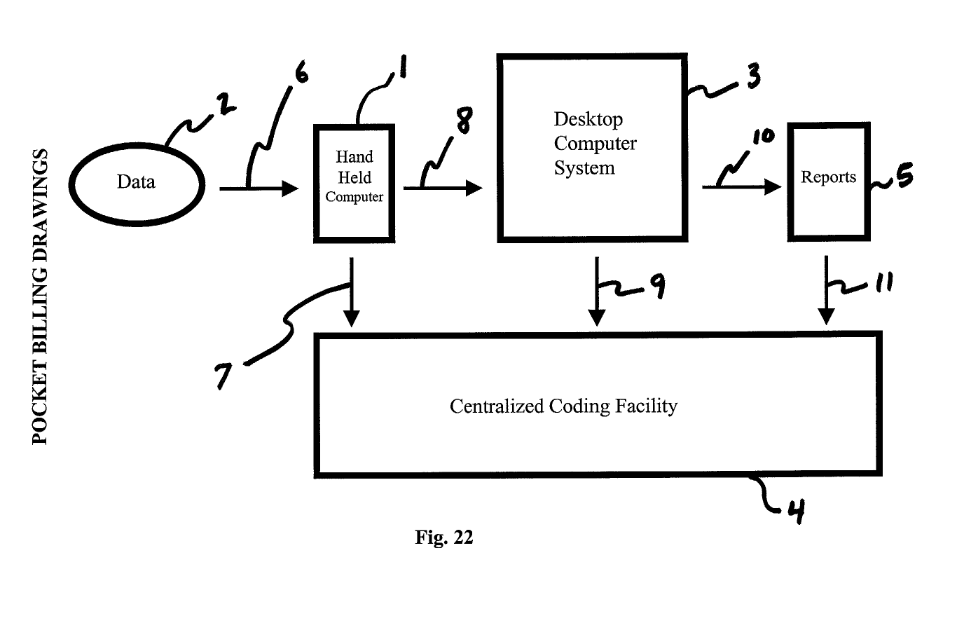

FIG. 22 shows the Pocket Billing Data Flow Diagram, which reflects that the Data 2 is captured by the user using a Hand Held Computer 1, through the process of Mobile Charge Capture (“MCC”) 6. Upon particular healthcare services being rendered, the healthcare provider selects or enters all the relevant information into the Hand Held Computer 1, and then the Hand Held Computer 1 and/or the Desktop Computer System 3 will make the selections and entries automatically. The Hand Held Computer 1 will then transmit the relevant information to the Desktop Computer System 3 and/or the Centralized Coding Facility 4. If the Hand Held Computer 1 transmits the relevant information to the Desktop Computer System 3, the Desktop Computer System 3 will in turn transmit the relevant information to the Centralized Coding Facility 4, with or without analysis and processing of the Data before it is transmitted to the Centralized Coding Facility 4. Each transmission to the Centralized Coding Facility 4 is referred to as an Electronic Charge Submission (“ECS”) 7 & 9. In addition, the Desktop Computer System 3 may process the relevant information further and make period transmissions to the Centralized Coding Facility 4, to the patient directly for the purpose of informing the patient or billing the patient directly, or to check the status of a payment request from any third party, for example. Also, the Desktop Computer System 3 may generate any number of traditional or customized paper Reports 5 for record keeping purposes or for further submission to the Centralized Coding Facility 4. However, the paper transmission 11 is simply not an expedient, cost effective or efficient method of transmission, as compared to the superior Electronic Charge Submission (“ECS”) 7 & 9 method.

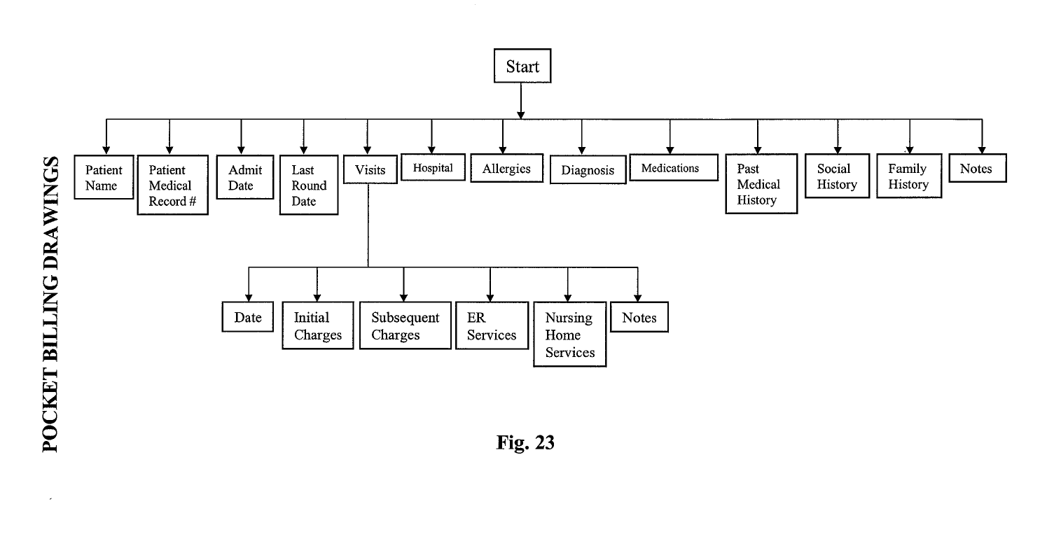

FIG. 23 shows an organization chart of most Relevant Information used in the process which is the subject of the current invention. The Relevant Information includes the Patient Name, the Patient Medical Record Number, the Admittance Date, the Last Round Date, Visit information, the Hospital, Allergies, Diagnosis, Medications, the Past Medical History, the Social History, the Family History and Notes. Upon a patient receiving healthcare services, referred to as a Visit, the appropriate charges are selected from the appropriate sub-databases. Thereafter, the Relevant Information and charge information is submitted to the insurance company or other paying agency through the Centralized Coding Facility 4.

Variations or modifications to the subject matter of this invention may occur to those skilled in the art upon reviewing the disclosure as provided herein. Any variations, which are yet within the scope of the development as described are intended to be encompassed within any invention upon this process, system and method. The descriptions of the preferred embodiment as provided herein is set forth for illustrative purposes only.

Having set forth the general nature and specific embodiments of the present invention, the true scope is now particularly pointed out in the appended claims.

What is claimed is:

1. A method for capturing and encoding healthcare services and processing healthcare claims, said method comprising the following steps:
(a) Capturing Healthcare Services;
(b) Encoding Healthcare Services; and
(b) Processing Healthcare Claims;
wherein the step of Processing Healthcare claims includes submitting the Healthcare Claims to a Centralized Coding Facility.

2. The method according to claim 1, wherein the step of Capturing Healthcare Services includes capturing Relevant Information at the point of service utilizing a Hand Held Computer.

3. The method according to claim 2, wherein:
the step of Capturing Healthcare Services includes capturing one or more of the following items of Relevant Information: Patient Information, Patient History, Hospital Information, and Specific Instances of Services, and storing said Relevant Information in the Hand Held Computer 1 system; and
the step of Encoding Healthcare Services includes generating one or more of the following Charge Codes: an Initial Charges Code, a Subsequent Charges Code, a Procedures Charges Code, an Emergency Room Services Charges Code, and a Nursing Home Visits Charges Code; and
the Specific Instances of Services will include one or more of the following services: Service Location, Patient Allergies, Patient Diagnosis, Patient Medications, Patient Past Surgical History, Patient Past Social History, Patient Family History and Notes.

4. The method according to claim 3, wherein the Charge Codes are automatically generated by software in the Hand Held Computer 1 and/or in a Desk Top Computer System to which the Hand Held Computer System transmits the Relevant Information and/or Specific Instances of Services.

5. The method according to claim 4, wherein the user of the Hand Held Computer 1 may either accept the automatically generated Charge Codes, or manually select the Charge Codes, or define and select a Customized Charge Code.

6. The method according to claim 5, wherein:
the submission of Healthcare Claims to a Centralized Coding Facility is accomplished by sending an electronic transmission from the Hand Held Computer to the Centralized Coding Facility, where said electronic transmission may be comprised of a transmission by e-mail, over a local area network, over the internet, by means of a modem connection, or by means of another hardwired connection between the Hand Held Computer and the Centralized Coding Facility.

7. The method according to claim 5, wherein:
the submission of Healthcare claims to a Centralized Coding Facility is accomplished by sending a wireless transmission from the Hand Held Computer to the Centralized Coding Facility.

8. The method according to claim 5, wherein:
the submission of Healthcare Claims to a Centralized Coding Facility is accomplished by sending an infra-red beam from the Hand Held Computer to the Centralized Coding Facility.

9. The method according to claim 5, wherein:
the submission of Healthcare Claims to a Centralized Coding Facility is accomplished by sending a First Transmission from the Hand Held Computer to a Desktop Computer System, and then by sending a Second Transmission from the Desktop Computer System to the Centralized Coding Facility.

10. The method according to claim 9, wherein:
the First Transmission is an electronic transmission by one of the following means: by e-mail, over a local area network, over the internet, by means of a modem connection, or by means of another hardwired connection between the Hand Held Computer and the Desktop Computer System.

11. The method according to claim 9, wherein:
the First Transmission is a wireless transmission.

12. The method according to claim 9, wherein:
the First Transmission is an infra-red beam transmission.
